(19) United States
(12) Patent Application Publication
(10) Pub. No.: US 2023/0016533 A1
(43) Pub. Date: Jan. 19, 2023

(54) SLOWLY DIGESTIBLE STARCH (SDS) AND PREPARATION METHOD AND USE THEREOF

(71) Applicant: Qingdao Agricultural University, Qingdao City (CN)

(72) Inventors: Qingjie Sun, Qingdao City (CN); Congli Cui, Qingdao City (CN); Na Ji, Qingdao City (CN); Qianzhu Lin, Qingdao City (CN); Kaili Qin, Qingdao City (CN); Han Jiang, Qingdao City (CN); Liu Xiong, Qingdao City (CN)

(73) Assignee: Qingdao Agricultural University, Qingdao City (CN)

(21) Appl. No.: 17/857,552

(22) Filed: Jul. 5, 2022

(30) Foreign Application Priority Data
Jul. 6, 2021 (CN) 202110760532.5

(51) Int. Cl. A23L 33/22; A23P 20/10; A23L 29/30; A23L 29/256; A23L 29/231

(52) U.S. Cl. CPC A23L 33/22; A23P 20/105; A23L 29/30; A23L 29/256; A23L 29/231; A23V 2002/00

(57) ABSTRACT

The present disclosure belongs to the technical field of starch processing, and in particular relates to slowly digestible starch (SDS) and a preparation method and use thereof. The SDS includes a starch granule and a non-starch polysaccharide coating coated on a surface of the starch granule. In the present disclosure, the non-starch polysaccharide coating coated on the surface of the starch granule can prevent an amylase from contacting the starch granule, increasing contents of the SDS and resistant starch (RS) in the SDS. Therefore, the SDS can delay a digestion process, increase a digestion time of the starch, and reduce the increase of blood glucose and insulin levels after the starch is digested and absorbed.

### TECHNICAL FIELD

The present disclosure belongs to the technical field of starch processing, and in particular relates to slowly digestible starch (SDS) and a preparation method and use thereof.

### BACKGROUND ART

Starch is a natural biopolymer that can be digested by α-amylase and α-glucosidase in the gastrointestinal tract to produce glucose, providing energy for the human body. According to the speed and degree of starch digestion, the starch includes rapidly digestible starch (RDS), slowly digestible starch (SDS), and resistant starch (RS). In recent years, clinical studies have found that the digestibility of starch is closely related to many diseases of the human body. The RDS induces rapid increases in blood glucose and insulin levels, leading to a range of complications, such as diabetes, obesity, and cardiovascular disease. Long-term high blood glucose may cause chronic damages to various tissues, especially heart and cerebral vessels, nerves, eyes, kidneys and limbs, inducing dysfunction and failure.

The SDS is slowly digested in the small intestine, allowing a slow and sustained release of glucose into the bloodstream, maintaining the low blood glucose and insulin levels. This helps control and prevent hyperglycemia-related diseases such as diabetes and obesity. The RS is barely digestible in the small intestine, cannot provide glucose, and is mainly utilized by microbes in the large intestine. Since SDS can be completely digested and absorbed by the human body to provide energy and integrating nutrition and function, the SDS has become a research hotspot in the field of food nutrition. It has become an urgent problem to be solved in the field of food nutrition to effectively increase the proportion of the SDS in starch.

### SUMMARY

An objective of the present disclosure is to provide SDS and a preparation method and use thereof. The SDS, with starch as a core and a non-starch polysaccharide as a shell, can effectively prolong the digestion time of the starch. Therefore, it can be used to develop the proportion of the SDS in the starch to maintain blood glucose and insulin levels after the starch digestion and absorption.

To achieve the above objective, the present disclosure provides the following technical solutions.

The present disclosure provides SDS, including a starch granule and a non-starch polysaccharide coating on the surface of starch granule; where the non-starch polysaccharide coating is obtained by crosslinking a non-starch polysaccharide with metal ions.

Preferably, the starch granule may include one or more of corn starch, potato starch, sweet potato starch, tapioca starch, pea starch, and mung bean starch.

Preferably, in the non-starch polysaccharide coating, the non-starch polysaccharide may include one or more of sodium alginate, carrageenan, and pectin.

Preferably, when the non-starch polysaccharide is the sodium alginate or the pectin, the metal ions may be calcium ions; and when the non-starch polysaccharide is the carrageenan, the metal ions may be potassium ions.

The present disclosure further provides a preparation method of the SDS, including the following four process routes:

Route I:

mixing starch with a non-starch polysaccharide solution to obtain a mixture of the non-starch polysaccharide and the starch; and

subjecting the mixture of the non-starch polysaccharide and the starch to a metal salt solution for crosslinking and solidification to obtain the SDS;

Route II:

mixing starch with a non-starch polysaccharide solution to obtain a mixture of the non-starch polysaccharide and the starch; and

drying the mixture of the non-starch polysaccharide and the starch, and subjecting a dried product to crosslinking and solidification in the metal salt solution to obtain the SDS;

Route III:

mixing starch with a non-starch polysaccharide solution to obtain a mixture of the non-starch polysaccharide and the starch; and

conducting microcapsule granulation on the mixture of the non-starch polysaccharide and the starch, and subjecting a granulated product to gelatinization in the metal salt solution to obtain the SDS; and

Route IV:

mixing starch with a non-starch polysaccharide solution to obtain a mixture of the non-starch polysaccharide and the starch; and

spraying the mixture of the non-starch polysaccharide and the starch into the metal salt solution by electrostatic spraying, and conducting crosslinking and solidification to obtain the SDS.

Preferably, in route I, the non-starch polysaccharide solution may have 2.5 g/L to 20.0 g/L of the non-starch polysaccharide;

in route II, the non-starch polysaccharide solution may have 2.5 g/L to 20.0 g/L of the non-starch polysaccharide;

in route III, the non-starch polysaccharide solution may have 5 g/L to 20.0 g/L of the non-starch polysaccharide; and

in route IV, the non-starch polysaccharide solution may have 2.5 g/L to 20.0 g/L of the non-starch polysaccharide.

Preferably, in routes I to IV, the starch and the non-starch polysaccharide solution may have a dosage ratio of independently (10-20) g: 100 mL.

The present disclosure further provides use of the SDS or SDS prepared by the preparation method in food.

The present disclosure provides SDS, including a starch granule and a non-starch polysaccharide coating coated on a surface of the starch granule. In the present disclosure, the non-starch polysaccharides and the metal ions undergo an ionic crosslinking reaction, such that the non-starch polysaccharides are connected by electrostatic interaction, and cover the surface of starch granule in the form of a coating, forming a core-shell structure with the starch as a core and the non-starch polysaccharide as a shell. During the digestion, the non-starch polysaccharide shell can reduce a contact area between digestive juice and the starch, thereby increasing a digestion time of the starch, reducing a digestion rate of the starch, and improving a proportion of the SDS in starch. The results of examples show that, in the present disclosure, SDS is prepared with the starch as a core and the non-starch polysaccharide as a shell. This SDS effectively reduces the contact area between the digestive juice and starch, increases the digestion time of starch, and reduces the digestion rate of starch. As a result, the starch has an SDS content increased from 8.4% to 34.5%, and an RS content increased from 3.8% to 20.4%.

### BRIEF DESCRIPTION OF THE DRAWINGS

To describe the embodiments of the present disclosure or the technical solutions in the related art more clearly, the accompanying drawings required in the embodiments are briefly introduced below. Obviously, the accompanying drawings described below are only some embodiments of the present disclosure. A person of ordinary skill in the art may further obtain other accompanying drawings based on these accompanying drawings without creative labor.

FIG. 1 shows an electron microscope image of a cross section of SDS obtained in Example 3; and

FIG. 2 shows digestion curve diagrams of the SDS obtained in Examples 5 to 8.

### DETAILED DESCRIPTION OF THE EMBODIMENTS

The present disclosure provides SDS, including a starch granule and a non-starch polysaccharide coating coated on a surface of the starch granule; where the non-starch polysaccharide coating is obtained by crosslinking a non-starch polysaccharide with metal ions.

The SDS includes the starch granule. The starch granule includes preferably one or more of corn starch, potato starch, sweet potato starch, tapioca starch, pea starch, and mung bean starch, more preferably one or more of the corn starch, the potato starch, and the pea starch.

In the present disclosure, the SDS further includes a non-starch polysaccharide coating coated on a surface of the starch granule, and the non-starch polysaccharide coating is obtained by crosslinking a non-starch polysaccharide with metal ions. In the non-starch polysaccharide coating, the non-starch polysaccharide includes preferably one or more of sodium alginate, carrageenan, and pectin, more preferably the sodium alginate; when the non-starch polysaccharide is the sodium alginate or the pectin, the metal ions are preferably calcium ions; and when the non-starch polysaccharide is the carrageenan, the metal ions are potassium ions. The non-starch polysaccharide and the metal ions undergo an ionic crosslinking reaction, such that the non-starch polysaccharide coating is adsorbed and covered on the surface of starch granule through hydrogen bond interaction.

In the present disclosure, the prepared SDS has preferably 30% to 40% of the SDS and preferably 15% to 25% of the RS.

The present disclosure further provides a preparation method of the SDS, including the following four process routes:

Route I:

mixing starch with a non-starch polysaccharide solution to obtain a mixture of the non-starch polysaccharide and the starch; and

subjecting the mixture of the non-starch polysaccharide and the starch to crosslinking and solidification in a metal salt solution to obtain the SDS.

In the present disclosure, the starch is mixed with the non-starch polysaccharide solution to obtain the mixture of the non-starch polysaccharide and the starch. The non-starch polysaccharide solution has preferably 2.5 g/L to 20.0 g/L, more preferably 5 g/L to 15 g/L, and further more preferably 10 g/L of the non-starch polysaccharide; and the starch and the non-starch polysaccharide solution have a dosage ratio of preferably (10-20) g: 100 mL, more preferably 15 g: 100 mL. When the non-starch polysaccharide in the non-starch polysaccharide solution is the sodium alginate, a preparation method of the non-starch polysaccharide solution includes: dissolving the sodium alginate in water at 25° C. to 50° C. for 1 h to 2 h to obtain a sodium alginate solution. When the non-starch polysaccharide in the non-starch polysaccharide solution is the carrageenan, a preparation method of the non-starch polysaccharide solution includes: dissolving the carrageenan in water at 85° C. to 95° C. for 30 min to obtain a carrageenan solution. When the non-starch polysaccharide in the non-starch polysaccharide solution is the pectin, a preparation method of the non-starch polysaccharide solution includes: dissolving the pectin in water at 75° C. to 85° C. for 30 min to obtain a pectin solution.

In the present disclosure, the mixture of the non-starch polysaccharide and the starch is subjected to crosslinking and solidification in the metal salt solution to obtain the SDS. The metal salt solution has a concentration of preferably 15 g/L to 25 g/L, more preferably 18 g/L to 22 g/L, and further more preferably 20 g/L; and the mixture of the non-starch polysaccharide and the starch and the metal salt solution have a volume ratio of preferably 1:(1-3), more preferably 1:2. The non-starch polysaccharide and the calcium ions undergo a crosslinking reaction, such that the non-starch polysaccharide is adsorbed on the surface of starch granule through hydrogen bond interaction to form the non-starch polysaccharide coating.

In the present disclosure, a preparation method of the metal salt solution includes the following steps: dissolving a metal salt in water to obtain the metal salt solution. In an example, the mixture of the non-starch polysaccharide and the starch is preferably added dropwise to the metal salt solution for crosslinking and solidification, and an obtained product is washed and dried in sequence to obtain the SDS. The crosslinking and solidification is conducted at preferably 20° C. to 30° C., more preferably 25° C. for preferably 0.5 h to 1.5 h, more preferably 1 h, which starts from completion of the dropwise addition of the mixture of the non-starch polysaccharide and the starch. The washing is conducted preferably by distilled water 3 to 4 times, and the drying is conducted preferably at 45° C. for 12 h. On this basis, the metal salt solution on a surface of the SDS can be removed.

Route II:

mixing starch with a non-starch polysaccharide solution to obtain a mixture of the non-starch polysaccharide and the starch; and

drying the mixture of the non-starch polysaccharide and the starch, and subjecting a dried product to crosslinking and solidification in the metal salt solution to obtain the SDS.

In the present disclosure, the starch is mixed with the non-starch polysaccharide solution to obtain the mixture of the non-starch polysaccharide and the starch. In route II, the non-starch polysaccharide solution has preferably 2.5 g/L to 20 g/L, more preferably 5 g/L to 15 g/L of the non-starch polysaccharide; a dosage ratio of the starch and the non-starch polysaccharide solution, and a preparation method of the non-starch polysaccharide solution are consistent with those of route I, and will not be repeated here.

In the present disclosure, the mixture of the non-starch polysaccharide and the starch is dried, and the dried product is subjected to crosslinking and solidification in the metal salt solution to obtain the SDS. The metal salt solution has a concentration of preferably 10 g/L to 20 g/L, more preferably 12.5 g/L to 17.5 g/L, and further more preferably 15 g/L; the mixture of the non-starch polysaccharide and the starch and the metal salt solution have a volume ratio of preferably 1:(1-3), more preferably 1:2; and the drying is conducted at preferably 40° C. to 50° C. for preferably 10 h to 14 h. The non-starch polysaccharide and the metal ions undergo a crosslinking reaction, such that the polysaccharide coating is adsorbed on the surface of starch granule through hydrogen bond interaction.

In the present disclosure, the crosslinking and solidification is conducted at preferably 20° C. to 30° C., more preferably 25° C. for preferably 0.5 h to 1.5 h, more preferably 1 h.

In an example, preferably the mixture of the non-starch polysaccharide and the starch is poured into a plate, and dried at 45° C.; a dried product is added to the metal salt solution and soaked for 0.5 h to 1.5 h, and a soaked system is dried, pulverized and sieved in sequence to obtain the SDS.

Route III:

mixing starch with a non-starch polysaccharide solution to obtain a mixture of the non-starch polysaccharide and the starch; and

conducting microcapsule granulation on the mixture of the non-starch polysaccharide and the starch, and subjecting a granulated product to gelatinization in the metal salt solution to obtain the SDS.

In the present disclosure, the starch is mixed with the non-starch polysaccharide solution to obtain the mixture of the non-starch polysaccharide and the starch. In route III, the non-starch polysaccharide solution has preferably 5 g/L to 20 g/L, more preferably 7.5 g/L to 15 g/L of the non-starch polysaccharide; a dosage ratio of the starch and the non-starch polysaccharide solution, and a preparation method of the non-starch polysaccharide solution are consistent with those of route I, and will not be repeated here.

In the present disclosure, microcapsule granulation is conducted on the mixture of the non-starch polysaccharide and the starch, and the granulated product is subjected to gelatinization in the metal salt solution to obtain the SDS. The metal salt solution has a concentration of preferably 5 g/L to 20 g/L, more preferably 7.5 g/L to 17.5 g/L, more preferably 15 g/L; and the mixture of the non-starch polysaccharide and the starch and the metal salt solution have a volume ratio of preferably 1:(1-3), more preferably 1:2. Sodium alginate microcapsules containing the starch granule are preferably prepared using a microcapsule granulator (BUCHI, B-395 Pro) concentric nozzle system; during the granulation, the non-starch polysaccharide is coated on the surface of starch granule.

In the present disclosure, the gelatinization is conducted at preferably 20° C. to 30° C., more preferably 25° C. for preferably 0.5 h to 1.5 h, more preferably 1 h; the gelatinization is specifically to immerse the granulated product in the metal salt solution. The gelatinization increases a mechanical strength of the non-starch polysaccharide coating.

Route IV:

mixing starch with a non-starch polysaccharide solution to obtain a mixture of the non-starch polysaccharide and the starch; and

spraying the mixture of the non-starch polysaccharide and the starch into the metal salt solution by electrostatic spraying, and conducting crosslinking and solidification to obtain the SDS.

In the present disclosure, the starch is mixed with the non-starch polysaccharide solution to obtain the mixture of the non-starch polysaccharide and the starch. In route IV, the non-starch polysaccharide solution has preferably 2.5 g/L to 20 g/L, more preferably 5 g/L to 15 g/L of the non-starch polysaccharide; a dosage ratio of the starch and the non-starch polysaccharide solution, and a preparation method of the non-starch polysaccharide solution are consistent with those of route I, and will not be repeated here.

In the present disclosure, the mixture of the non-starch polysaccharide and the starch is sprayed into the metal salt solution by electrostatic spraying, and crosslinking and solidification is conducted to obtain the SDS. The metal salt solution has a concentration of preferably 10 g/L to 20 g/L, more preferably 12.5 g/L to 17.5 g/L, and further more preferably 15 g/L; the mixture of the non-starch polysaccharide and the starch and the metal salt solution have a volume ratio of preferably 1:(1-3), more preferably 1:2; and the electrostatic spraying is conducted at a voltage of preferably 10 kV to 20 kV, a distance of preferably 10 cm to 20 cm, and a pushing speed of preferably 0.02 cm/min to 0.1 cm/min.

In the present disclosure, the crosslinking and solidification is conducted at preferably 20° C. to 30° C., more preferably 25° C. for preferably 0.5 h to 1.5 h, more preferably 1 h.

In the present disclosure, after the crosslinking and solidification, an obtained mixed system is preferably subjected to centrifugation, washing and drying in sequence to obtain the SDS; the washing is preferably conducted by distilled water 3 to 4 times, and the drying is conducted preferably at 45° C. for 12 h. On this basis, the metal salt solution on the surface of SDS can be removed.

In the present disclosure, in routes Ito IV, the metal salt is preferably a chloride salt of a corresponding metal, specifically potassium chloride or calcium chloride.

In the above preparation methods, the non-starch polysaccharides and the metal ions undergo an ionic crosslinking reaction, such that the non-starch polysaccharides are connected through hydrogen bond interaction and cover the surface of starch granule in the form of a coating. As a result, the SDS based on a core-shell structure is formed with the starch as a core and the non-starch polysaccharide as a shell.

The present disclosure further provides use of the SDS or SDS prepared by the preparation method in food, specifically in solid beverages or staple foods, more specifically in starch and starch products, cereal products, fillings, baked goods, and cakes. There is no special limitation on a specific method of the use, and methods well known to those skilled in the art can be used.

In order to further illustrate the present disclosure, the SDS provided by the present disclosure will be described in detail below in connection with examples, but they should not be construed as limiting the claimed scope of the present disclosure.

### EXAMPLE 1

0.25 g of sodium alginate was dissolved in 100 mL of water at 40° C. for 1 h to obtain a sodium alginate solution. 2 g of calcium chloride was dissolved in 100 mL of water, while 10 g of potato starch was evenly dispersed in 100 mL of the sodium alginate solution by fully stirring; a blend of the sodium alginate and the potato starch was added dropwise to a prepared calcium chloride solution to form SDS. The SDS was solidified in the calcium chloride solution for 1 h for fully crosslinking; a crosslinked product was washed with distilled water 3 to 4 times to remove the calcium chloride solution, and washed SDS was dried in an oven at 45° C. for 12 h to obtain SDS CA_{0.25}PS₁₀.

### EXAMPLE 2

0.5 g of sodium alginate was dissolved in 100 mL of water at 40° C. for 1 h to obtain a sodium alginate solution. 2 g of calcium chloride was dissolved in 100 mL of water, while 10 g of potato starch was evenly dispersed in 100 mL of the sodium alginate solution by fully stirring; a blend of the sodium alginate and the potato starch was added dropwise to a prepared calcium chloride solution to form SDS. The SDS was solidified in the calcium chloride solution for 1 h for fully crosslinking; a crosslinked product was washed with distilled water 3 to 4 times to remove the calcium chloride solution, and washed SDS was dried in an oven at 45° C. for 12 h to obtain SDS CA_{0.5}PS₁₀.

### EXAMPLE 3

1 g of sodium alginate was dissolved in 100 mL of water at 40° C. for 1 h to obtain a sodium alginate solution. 2 g of calcium chloride was dissolved in 100 mL of water, while 10 g of potato starch was evenly dispersed in 100 mL of the sodium alginate solution by fully stirring; a blend of the sodium alginate and the potato starch was added dropwise to a prepared calcium chloride solution to form SDS. The SDS was solidified in the calcium chloride solution for 1 h for fully crosslinking; a crosslinked product was washed with distilled water 3 to 4 times to remove the calcium chloride solution, and washed SDS was dried in an oven at 45° C. for 12 h to obtain SDS CA₁PS₁₀.

### EXAMPLE 4

2 g of sodium alginate was dissolved in 100 mL of water at 40° C. for 1 h to obtain a sodium alginate solution. 2 g of calcium chloride was dissolved in 100 mL of water, while 10 g of potato starch was evenly dispersed in 100 mL of the sodium alginate solution by fully stirring; a blend of the sodium alginate and the potato starch was added dropwise to a prepared calcium chloride solution to form SDS. The SDS was solidified in the calcium chloride solution for 1 h for fully crosslinking; a crosslinked product was washed with distilled water 3 to 4 times to remove the calcium chloride solution, and washed SDS was dried in an oven at 45° C. for 12 h to obtain SDS CA₂PS₁₀.

### EXAMPLE 5

0.25 g of sodium alginate was dissolved in 100 mL of water at 40° C. for 1 h to obtain a sodium alginate solution. 2 g of calcium chloride was dissolved in 100 mL of water, while 20 g of potato starch was evenly dispersed in 100 mL of the sodium alginate solution by fully stirring; a blend of the sodium alginate and the potato starch was added dropwise to a prepared calcium chloride solution to form SDS. The SDS was solidified in the calcium chloride solution for 1 h for fully crosslinking; a crosslinked product was washed with distilled water 3 to 4 times to remove the calcium chloride solution, and washed SDS was dried in an oven at 45° C. for 12 h to obtain SDS CA_{0.25}PS₂₀.

### EXAMPLE 6

0.5 g of sodium alginate was dissolved in 100 mL of water at 40° C. for 1 h to obtain a sodium alginate solution. 2 g of calcium chloride was dissolved in 100 mL of water, while 20 g of potato starch was evenly dispersed in 100 mL of the sodium alginate solution by fully stirring; a blend of the sodium alginate and the potato starch was added dropwise to a prepared calcium chloride solution to form SDS. The SDS was solidified in the calcium chloride solution for 1 h for fully crosslinking; a crosslinked product was washed with distilled water 3 to 4 times to remove the calcium chloride solution, and washed SDS was dried in an oven at 45° C. for 12 h to obtain SDS CA_{0.5}PS₂₀.

### EXAMPLE 7

1 g of sodium alginate was dissolved in 100 mL of water at 40° C. for 1 h to obtain a sodium alginate solution. 2 g of calcium chloride was dissolved in 100 mL of water, while 20 g of potato starch was evenly dispersed in 100 mL of the sodium alginate solution by fully stirring; a blend of the sodium alginate and the potato starch was added dropwise to a prepared calcium chloride solution to form SDS. The SDS was solidified in the calcium chloride solution for 1 h for fully crosslinking; a crosslinked product was washed with distilled water 3 to 4 times to remove the calcium chloride solution, and washed SDS was dried in an oven at 45° C. for 12 h to obtain SDS CA₁PS₂₀.

### EXAMPLE 8

2 g of sodium alginate was dissolved in 100 mL of water at 40° C. for 1 h to obtain a sodium alginate solution. 2 g of calcium chloride was dissolved in 100 mL of water, while 20 g of potato starch was evenly dispersed in 100 mL of the sodium alginate solution by fully stirring; a blend of the sodium alginate and the potato starch was added dropwise to a prepared calcium chloride solution to form SDS. The SDS was solidified in the calcium chloride solution for 1 h for fully crosslinking; a crosslinked product was washed with distilled water 3 to 4 times to remove the calcium chloride solution, and washed SDS was dried in an oven at 45° C. for 12 h to obtain SDS CA₂PS₂₀.

### EXAMPLE 9

0.5 g of carrageenan was dissolved in 100 mL of water at 90° C. for 30 min to obtain a carrageenan solution. 2 g of potassium chloride was dissolved in 100 mL of water, while 10 g of potato starch was evenly dispersed in 100 mL of the carrageenan solution by fully stirring; a blend of the carrageenan and the potato starch was added dropwise to a prepared potassium chloride solution to form SDS. The SDS was solidified in the potassium chloride solution for 1 h for fully crosslinking; a crosslinked product was washed with distilled water 3 to 4 times to remove the potassium chloride solution, and washed SDS was dried in an oven at 45° C. for 12 h to obtain the SDS.

### EXAMPLE 10

0.5 g of pectin was dissolved in 100 mL of water at 80° C. for 30 min to obtain a pectin solution. 2 g of calcium chloride was dissolved in 100 mL of water, while 10 g of potato starch was evenly dispersed in 100 mL of the pectin solution by fully stirring; a blend of the pectin and the potato starch was added dropwise to a prepared calcium chloride solution to form SDS. The SDS was solidified in the calcium chloride solution for 1 h for fully crosslinking; a crosslinked product was washed with distilled water 3 to 4 times to remove the calcium chloride solution, and washed SDS was dried in an oven at 45° C. for 12 h to obtain the SDS.

### EXAMPLE 11

2 g of sodium alginate was dissolved in 100 mL of water at 40° C. for 1 h to obtain a sodium alginate solution. 2 g of calcium chloride was dissolved in 100 mL of water, while 20 g of potato starch was evenly dispersed in 100 mL of the sodium alginate solution by fully stirring; a dispersion was poured into a plate, and dried at 45° C. to 60° C. for 12 h to 16 h to obtain a dried product. The dried product was ground and sieved to obtain a powder. The powder was dispersed uniformly in an obtained 2% calcium chloride solution to conduct a reaction for 1 h. A resulting dispersion was centrifuged, washed with distilled water 3 to 4 times to remove the calcium chloride solution, and washed SDS was dried in an oven at 45° C. for 12 h to obtain the SDS.

### EXAMPLE 12

1 g of sodium alginate was dissolved in 100 mL of water at 40° C. for 1 h to obtain a sodium alginate solution. 2 g of calcium chloride was dissolved in 100 mL of water, while 10 g of potato starch was evenly dispersed in 100 mL of the sodium alginate solution by fully stirring; a blend of the sodium alginate and the potato starch was sprayed into an obtained calcium chloride solution through a microcapsule granulator to form SDS. The SDS was solidified in the calcium chloride solution for 1 h for fully crosslinking; a crosslinked product was washed with distilled water 3 to 4 times to remove the calcium chloride solution, and washed SDS was dried in an oven at 45° C. for 12 h to obtain the SDS.

### EXAMPLE 13

0.25 g of sodium alginate was dissolved in 100 mL of water at 40° C. for 1 h to obtain a sodium alginate solution. 2 g of calcium chloride was dissolved in 100 mL of water, while 10 g of potato starch was evenly dispersed in 100 mL of the sodium alginate solution by fully stirring; a blend of the sodium alginate and the potato starch was put into a 5 ml syringe, placed on an electrospinning machine at a voltage of 10 kv, a distance of 10 cm, and a pushing speed of 0.02 cm/min. A mixture of the starch and the polysaccharide was sprayed into an obtained calcium chloride solution under the action of an electric field to form SDS. The SDS was solidified in the calcium chloride solution for 1 h for fully crosslinking; a crosslinked product was washed with distilled water 3 to 4 times to remove the calcium chloride solution, and washed SDS was dried in an oven at 45° C. for 12 h to obtain the SDS.

### EXAMPLE 14

0.25 g of sodium alginate was dissolved in 100 mL of water at 40° C. for 1 h to obtain a sodium alginate solution. 2 g of calcium chloride was dissolved in 100 mL of water, while 10 g of potato starch was evenly dispersed in 100 mL of the sodium alginate solution by fully stirring; a blend of the sodium alginate and the potato starch was put into a 5 ml syringe, placed on an electrospinning machine at a voltage of 10 kv, a distance of 10 cm, and a pushing speed of 0.02 cm/min. A mixture of the starch and the polysaccharide was sprayed into an obtained calcium chloride solution under the action of an electric field to form SDS. The SDS was solidified in the calcium chloride solution for 1 h for fully crosslinking; a crosslinked product was washed with distilled water 3 to 4 times to remove the calcium chloride solution, and washed SDS was dried in an oven at 45° C. for 12 h to obtain the SDS.

### EXAMPLE 15

0.45 g of sodium alginate was dissolved in 100 mL of water at 40° C. for 1 h to obtain a sodium alginate solution. 2 g of calcium chloride was dissolved in 100 mL of water, while 10 g of potato starch was evenly dispersed in 100 mL of the sodium alginate solution by fully stirring; a blend of the sodium alginate and the potato starch was put into a 5 ml syringe, placed on an electrospinning machine at a voltage of 10 kv, a distance of 10 cm, and a pushing speed of 0.02 cm/min. A mixture of the starch and the polysaccharide was sprayed into an obtained calcium chloride solution under the action of an electric field to form SDS. The SDS was solidified in the calcium chloride solution for 1 h for fully crosslinking; a crosslinked product was washed with distilled water 3 to 4 times to remove the calcium chloride solution, and washed SDS was dried in an oven at 45° C. for 12 h to obtain the SDS.

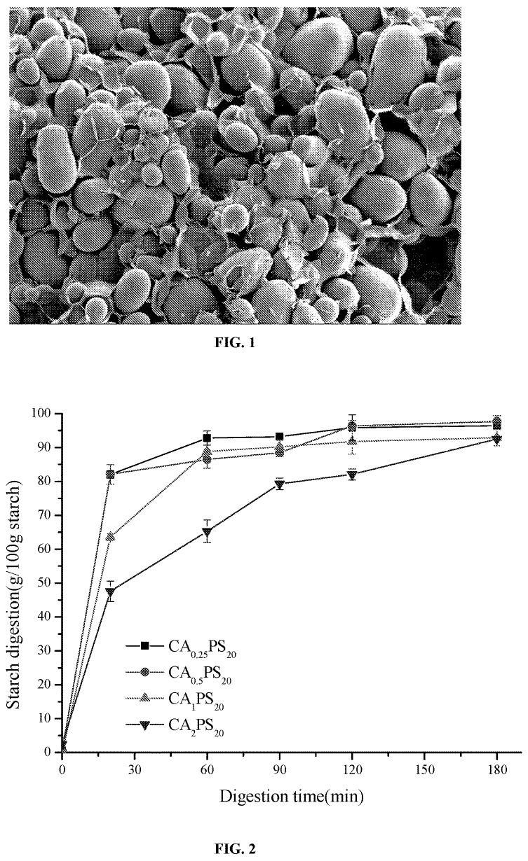

The SDS prepared in Example 3 was cut open, sprayed with gold, and a cross section thereof was observed with a scanning electron microscope. The results are shown in FIG. 1. FIG. 1 shows an electron microscope image of the cross section of the SDS obtained in Example 3. As can be seen from FIG. 1, in the SDS obtained in Example 3, a surface of the potato starch granule is uniformly covered with a calcium alginate coating, having a uniform thickness of about 100 nm.

The mechanical properties of SDS prepared in Examples 1 to 8 were tested. A testing method for the mechanical properties included: the SDS was placed directly under a P 36R probe of a physical property analyzer, and three parallel measurements were conducted at a compression ratio of 30% and a test speed of 1 mm/s. The test results are shown in Table 1. Table 1 shows an encapsulation efficiency and mechanical properties of the SDS obtained in Examples 1 to 8.

TABLE 1
Encapsulation efficiency and mechanical properties
of SDS obtained in Examples 1 to 8

| | | | | Encapsulation |
|---|---|---|---|---|
| Sample | Hardness (g) | Adhesivity | Elasticity | efficiency (%) |
| CA_{0.25}PS₁₀ | 164.22 ± 25.34^{a} | −13.25 ± 1.69^{a} | 0.50 ± 0.00^{ab} | 98.28 ± 0.88^{a} |
| CA_{0.5}PS₁₀ | 208.05 ± 1.62^{b} | −7.44 ± 0.56^{b} | 0.57 ± 0.00^{b} | 99.88 ± 0.04^{b} |
| CA₁PS₁₀ | 322.78 ± 21.55^{d} | −2.76 ± 1.33^{cd} | 0.71 ± 0.03^{c} | 99.89 ± 0.07^{b} |
| CA₂PS₁₀ | 434.81 ± 19.31^{e} | −0.59 ± 0.04^{d} | 0.75 ± 0.00^{c} | 99.71 ± 0.19^{b} |
| CA_{0.25}PS₂₀ | 275.42 ± 1.05^{c} | −2.71 ± 0.91^{cd} | 0.45 ± 0.02^{a} | 98.42 ± 0.85^{a} |
| CA_{0.5}PS₂₀ | 274.43 ± 26.15^{c} | −5.64 ± 1.80^{bc} | 0.49 ± 0.00^{ab} | 99.90 ± 0.02^{b} |
| CA₁PS₂₀ | 405.55 ± 1.28^{e} | −10.39 ± 0.30^{a} | 0.69 ± 0.02^{c} | 99.96 ± 0.00^{b} |
| CA₂PS₂₀ | 541.33 ± 6.70^{g} | −0.97 ± 0.01^{d} | 0.76 ± 0.01^{c} | 99.86 ± 0.04^{b} |

It can be seen from Table 1 that with an increase of the sodium alginate concentration, the non-starch polysaccharide coating (calcium alginate coating) has an improved encapsulation efficiency for starch, reaching as high as 99.96%. At this time, a small amount of starch not encapsulated in the non-starch polysaccharide coating is dispersed in the solution. When the concentration of potato starch is constant, the hardness and elasticity of SDS increase with an increase of the sodium alginate concentration, while the adhesivity of SDS decreases with the increase of the sodium alginate concentration. When the concentration of sodium alginate is 2% and the concentration of potato starch is 20%, the hardness reaches a maximum of 541.33 g, and the elasticity reaches a maximum of 0.76. The reason may be that due to the increased concentration of sodium alginate, a gel network formed with calcium ions has a high density and high strength, which can prevent potato starch granules from falling off, and can improve the hardness and elasticity.

The initial gelatinization temperature, peak temperature, end temperature, and enthalpy of the SDS prepared in Examples 1 to 8 were determined using a differential scanning calorimeter (DSC). The method included: the SDS was placed in an aluminum crucible, water was added and balanced for 6 h, and thermal properties of the SDS were measured, while the potato starch was used as a control. The DSC had parameters as follows: an initial temperature of 25° C., an end temperature of 125° C., and a heating rate of 10° C./min; and 3 parallel measurements were conducted. The test results are shown in Table 2. Table 2 shows thermal properties of the SDS and the potato starch.

TABLE 2
Thermal properties of SDS obtained in Examples 1 to 8 and potato starch

| | Initial gelatinization | Peak | End | Enthalpy |
|---|---|---|---|---|
| Name | temperature (° C.) | value (° C.) | temperature (° C.) | (J g⁻¹) |
| PS | 58.99 ± 0.08^{a} | 62.76 ± 0.04^{a} | 67.63 ± 0.81^{a} | 7.56 ± 1.36^{a} |
| CA_{0.25}PS₁₀ | 60.80 ± 0.91^{ab} | 64.73 ± 0.01^{b} | 70.48 ± 0.93^{b} | 9.05 ± 0.68^{bc} |
| CA_{0.5}PS₁₀ | 63.20 ± 0.17^{d} | 67.70 ± 0.04^{cd} | 74.76 ± 1.09^{c} | 10.16 ± 0.23^{cd} |
| CA₁PS₁₀ | 63.81 ± 0.04^{d} | 68.69 ± 0.10^{d} | 77.24 ± 0.94^{d} | 10.06 ± 0.03^{bcd} |
| CA₂PS₁₀ | 61.11 ± 0.33^{bc} | 68.13 ± 0.06^{cd} | 81.74 ± 0.37^{e} | 11.47 ± 0.71^{d} |
| CA_{0.25}PS₂₀ | 60.19 ± 0.68^{ab} | 64.48 ± 0.37^{b} | 69.93 ± 0.11^{b} | 8.69 ± 0.22^{ab} |
| SA_{0.5}PS₂₀ | 63.05 ± 0.89^{cd} | 67.31 ± 1.21^{c} | 74.83 ± 1.44^{c} | 8.68 ± 0.09^{ab} |
| CA₁PS₂₀ | 62.96 ± 0.36^{cd} | 67.79 ± 0.52^{cd} | 76.04 ± 1.12^{cd} | 10.60 ± 0.16^{d} |
| CA₂PS₂₀ | 64.10 ± 0.11^{d} | 69.87 ± 0.29^{e} | 80.52 ± 0.11^{e} | 10.17 ± 0.40^{cd} |

It can be seen from Table 2 that the potato starch has an initial gelatinization temperature of 58.99° C., a peak temperature of 62.76° C., and an end temperature of 67.63° C.; the SDS has an initial gelatinization temperature of 64.10° C., a peak temperature of 69.87° C., and an end temperature of 81.74° C. The potato starch with calcium alginate coating has an enthalpy increased from 7.56 J·g⁻¹ to 11.47 J·g⁻¹. By comparing the potato starch and SDS, it can be seen that the gelatinization temperature, peak temperature, end temperature, and enthalpy of SDS with non-starch polysaccharide coating each increase, indicating that the SDS is not easy to gelatinize.

The SDS and the potato starch prepared in Examples 1 to 8 were placed in water, cooled to room temperature after 30 min of treatment in a water bath at different temperatures of 55° C., 65° C., 75° C., 85° C., and 95° C., and centrifuged at 4,000 rpm for 15 min; a supernatant was removed, and residues were weighed for swelling determination. The supernatant was poured from the test tube into glass dishes of known weights, dried to a constant weight at 105° C. and weighed, where all measurements were repeated three times. The test results are shown in Table 3. Table 3 shows a swelling degree and a solubility of the SDS obtained in Examples 1 to 8 and the potato starch.

TABLE 3
Swelling degree and solubility of SDS obtained in Examples 1 to 8 and potato starch

| | | | | | | | | | |
|---|---|---|---|---|---|---|---|---|---|
| Temperature | | | | | | | | | |
| (° C.) | PS | CA_{0.25}PS₁₀ | CA_{0.5}PS₁₀ | CA₁PS₁₀ | CA₂PS₁₀ | CA_{0.25}PS₂₀ | CA_{0.5}PS₂₀ | CA₁PS₂₀ | CA₂PS₂₀ |

Swelling degree(g/g)

| | | | | | | | | | |
|---|---|---|---|---|---|---|---|---|---|
| 55° C. | 6.3 ± 0.0^{c} | 4.4 ± 0.2^{b} | 3.6 ± 0.0^{ab} | 3.3 ± 0.0^{a} | 3.2 ± 0.3^{a} | 3.5 ± 0.0^{a} | 3.2 ± 0.1^{a} | 3.2 ± 0.5^{a} | 3.1 ± 0.0^{a} |
| 65° C. | 19.5 ± 0.2^{f} | 8.5 ± 0.5^{e} | 6.7 ± 0.1^{d} | 6.2 ± 0.0^{cd} | 4.6 ± 0.6^{a} | 8.5 ± 0.3^{e} | 6.6 ± 0.4^{d} | 5.5 ± 0.4^{bc} | 4.8 ± 0.0^{ab} |
| 75° C. | 24.5 ± 1.1^{e} | 9.7 ± 0.3^{d} | 7.7 ± 0.0^{c} | 6.4 ± 0.1^{bc} | 4.7 ± 0.3^{a} | 9.8 ± 1.0^{d} | 7.7 ± 0.2^{c} | 6.5 ± 0.0^{bc} | 5.5 ± 0.4^{ab} |
| 85° C. | 28.7 ± 0.0^{e} | 10.2 ± 0.9^{d} | 8.3 ± 0.1^{c} | 7.0 ± 0.5^{b} | 5.3 ± 0.1^{a} | 10.6 ± 0.0^{d} | 8.5 ± 0.0^{c} | 7.2 ± 0.1^{b} | 5.5 ± 0.0^{a} |
| 95° C. | 31.1 ± 0.4^{g} | 13.3 ± 0.1^{f} | 8.3 ± 0.1^{c} | 7.2 ± 0.6^{ab} | 6.5 ± 0.1^{a} | 11.4 ± 0.4^{e} | 9.7 ± 0.2^{d} | 7.4 ± 0.0^{b} | 6.6 ± 0.4^{ab} |

Solubility (%)

| | | | | | | | | | |
|---|---|---|---|---|---|---|---|---|---|
| 55° C. | 2.3 ± 0.0^{bcd} | 1.3 ± 0.4^{abc} | 2.3 ± 0.0^{bcd} | 1.1 ± 0.7^{ab} | 3.1 ± 0.1^{d} | 2.5 ± 0.0^{cd} | 0.7 ± 0.0^{a} | 2.8 ± 0.4^{d} | 2.8 ± 0.1^{d} |
| 65° C. | 9.3 ± 0.8^{d} | 6.0 ± 0.0^{bc} | 3.8 ± 0.0^{ab} | 2.6 ± 0.0^{a} | 7.8 ± 1.2^{cd} | 8.3 ± 0.7^{cd} | 1.9 ± 0.4^{a} | 2.1 ± 1.1^{a} | 4.0 ± 1.0^{ab} |
| 75° C. | 9.6 ± 0.6^{e} | 6.1 ± 0.0^{d} | 3.5 ± 0.4^{b} | 2.2 ± 0.1^{a} | 10.2 ± 0.1^{e} | 9.5 ± 0.8^{e} | 5.7 ± 0.0^{cd} | 3.6 ± 0.1^{b} | 4.8 ± 1.0^{c} |
| 85° C. | 10.3 ± 0.1^{d} | 12.0 ± 0.0^{e} | 4.0 ± 1.1^{ab} | 3.1 ± 0.5^{a} | 11.6 ± 0.0^{de} | 12.0 ± 0.3^{e} | 6.3 ± 0.4^{c} | 5.3 ± 0.4^{bc} | 6.2 ± 1.0^{c} |
| 95° C. | 20.3 ± 0.5^{d} | 24.8 ± 1.2^{e} | 12.0 ± 0.2^{b} | 4.3 ± 0.1^{a} | 12.5 ± 1.0^{b} | 15.6 ± 0.5^{c} | 12.7 ± 0.6^{b} | 11.4 ± 1.7^{b} | 11.4 ± 0.3^{b} |

As can be seen from Table 3, when a temperature is lower than the gelatinization temperature, the potato starch maintains a granular structure, is insoluble in water, and has a low swelling degree; when the temperature increases, the potato starch granules gradually change into a molecular state, with increased solubility and swelling degree. Compared with potato starch, the solubility and swelling degree of SDS decreases, indicating that the non-starch polysaccharide coating has restricted the swelling and dissolution of starch, such that the starch cannot diffuse into the aqueous solution. Moreover, with the increase of sodium alginate concentration, the swelling degree of SDS decreases by 2 to 5 times at different temperatures, and the solubility of SDS decreases from 20.3% to 4.3% at 95° C.

Digestion tests were conducted on the SDS obtained in Examples 1 to 8 and the potato starch. A test method included: 3 g of pancreatin was dispersed in 20 mL of deionized water; after 10 min, 15 mL of a supernatant was transferred to a centrifuge tube, and 1.1 mL of amyloglucosidase was added to the solution; 200 mg of SDS and 18 mL of an acetate buffer solution at pH=5.20 were placed in a centrifuge tube, and gelatinized in a boiling water bath for 30 min; after the gelatinization was completed, a product was cooled to 37° C., 20 glass beads and 2 mL of a mixed enzyme solution were added to the centrifuge tube, and a mixture was incubated in a shaking water bath at 37° C.; after incubating the mixture for 0, 20 min, 60 min, 90 min, 120 min, and 180 min, 0.1 mL of aliquots were collected separately and mixed with 0.9 mL of a 90% ethanol solution; and a content of hydrolyzed glucose in a supernatant after centrifugation was determined by a K-GLUC kit.

The SDS digestibility test results are shown in Table 4 and FIG. 2. Table 4 shows contents of the RDS, SDS and RS in the SDS obtained in Examples 1 to 8 and the potato starch. FIG. 2 shows digestion curve diagrams of the SDS obtained in Examples 5 to 8.

TABLE 4
Contents of RDS, SDS and RS in SDS obtained
in Examples 1 to 8 and potato starch

| | RDS (%) | SDS (%) | RS (%) |
|---|---|---|---|
| PS | 85.9 ± 0.1^{a} | 10.2 ± 0.7^{ab} | 3.8 ± 0.8^{a} |
| CA_{0.25}PS₁₀ | 86.5 ± 0.7^{a} | 8.4 ± 1.1^{a} | 5.1 ± 0.4^{a} |
| CA_{0.5}PS₁₀ | 80.3 ± 1.3^{b} | 14.9 ± 1.3^{b} | 4.8 ± 2.6^{a} |
| CA₁PS₁₀ | 60.3 ± 0.6^{cd} | 26.7 ± 2.2^{c} | 12.9 ± 1.6^{b} |
| CA₂PS₁₀ | 60.0 ± 0.6^{d} | 32.0 ± 2.7^{de} | 8.4 ± 2.1^{ab} |
| CA_{0.25}PS₂₀ | 81.6 ± 0.4^{b} | 13.9 ± 2.8^{b} | 4.5 ± 3.2^{a} |
| CA_{0.5}PS₂₀ | 81.6 ± 3.5^{b} | 14.3 ± 1.2^{b} | 4.0 ± 2.3^{a} |
| CA₁PS₂₀ | 63.6 ± 1.1^{c} | 28.2 ± 2.7^{cd} | 8.3 ± 3.7^{ab} |
| CA₂PS₂₀ | 45.1 ± 2.2^{e} | 34.5 ± 1.5^{e} | 20.4 ± 0.7^{c} |

In Table 4, RDS (%), SDS (%), and RS (%) are mass fractions of the RDS, the SDS, and the RS, respectively. Formulas for calculating the mass fractions of the above-mentioned various types of starch are:

RDS(%)=(G₂₀−G₀)×0.9×100/TS

SDS(%)=(G₁₂₀−G₂₀)×0.9×100/TS

RS(%)=TS−(RDS+SDS)

In the formulas, G₀ is a content (mg) of free glucose in the starch before amylase hydrolysis; G₂₀ is an amount (mg) of glucose produced after 20 min of amylase hydrolysis; G₁₂₀ is an amount (mg) of glucose produced after 120 min of amylase hydrolysis; and TS is a total starch content (mg) in the sample.

As can be seen from Table 4, the SDS content in the prepared SDS is increased from 10.2% to 34.5%, and the RS content is increased from 3.8% to 20.4%. As can be seen from FIG. 2, since the non-starch polysaccharide coating can limit the contact between the enzyme and the starch, the hydrolysis of starch by the enzyme is reduced. Moreover, obviously CA₂PS₂₀ SDS has a slow digestion process, and the non-starch polysaccharide coating is covered on the surface of starch, preventing the contact between amylase and starch granules. Accordingly, the SDS and RS contents in the prepared SDS increase, resulting in a slow digestion process. However, as can also be seen from FIG. 2, about 95% of the starch is completely digested at 180 min. That is, the starch granules in the SDS can eventually be completely digested. This may be because there are pores on the surface of non-starch polysaccharide coating after the SDS solidification; as the digestion progresses, the pores provide a pathway for enzymes contacting with the starch, causing the starch inside non-starch polysaccharide coating to be hydrolyzed.

The same detection was conducted on the SDS prepared in Examples 9 to 15. The results show that polysaccharide coating is formed on the surface of starch, and the digestion time of starch is prolonged, such that the digestion speed of starch is obviously reduced.

From this point of view, the SDS provided by the present disclosure has the starch as a core and the non-starch polysaccharide as a shell. During the digestion, the SDS can effectively reduce a contact area between the digestive juice and starch, increase a digestion time of starch, and reduce a digestion speed of starch.

Although the above embodiments have described the present disclosure in a thorough manner, it is only some but not all embodiments of the present disclosure, and other embodiments may be obtained without inventive step according to the present embodiments, all of which fall within the scope of protection the present disclosure.

1. Slowly digestible starch (SDS), comprising a starch granule and a non-starch polysaccharide coating coated on a surface of the starch granule; wherein the non-starch polysaccharide coating is obtained by crosslinking a non-starch polysaccharide with metal ions.

2. The SDS according to claim 1, wherein the starch granule comprises one or more of corn starch, potato starch, sweet potato starch, tapioca starch, pea starch, and mung bean starch.

3. The SDS according to claim 2, wherein in the non-starch polysaccharide coating, the non-starch polysaccharide comprises one or more of sodium alginate, carrageenan, and pectin.

4. The SDS according to claim 3, wherein when the non-starch polysaccharide is the sodium alginate or the pectin, the metal ions are calcium ions; and when the non-starch polysaccharide is the carrageenan, the metal ions are potassium ions.

5. A preparation method of slowly digestible starch (SDS) comprising a starch granule and a non-starch polysaccharide coating coated on a surface of the starch granule; wherein the non-starch polysaccharide coating is obtained by crosslinking a non-starch polysaccharide with metal ions, the preparation method comprising the following four process routes:
route I:
mixing starch with a non-starch polysaccharide solution to obtain a mixture of the non-starch polysaccharide and the starch; and
subjecting the mixture of the non-starch polysaccharide and the starch to crosslinking and solidification in a metal salt solution to obtain the SDS;
route II:
mixing starch with a non-starch polysaccharide solution to obtain a mixture of the non-starch polysaccharide and the starch; and
drying the mixture of the non-starch polysaccharide and the starch, and subjecting a dried product to crosslinking and solidification in the metal salt solution to obtain the SDS;
route III:
mixing starch with a non-starch polysaccharide solution to obtain a mixture of the non-starch polysaccharide and the starch; and
conducting microcapsule granulation on the mixture of the non-starch polysaccharide and the starch, and subjecting a granulated product to gelatinization in the metal salt solution to obtain the SDS; and
route IV:
mixing starch with a non-starch polysaccharide solution to obtain a mixture of the non-starch polysaccharide and the starch; and
spraying the mixture of the non-starch polysaccharide and the starch into the metal salt solution by electrostatic spraying, and conducting crosslinking and solidification to obtain the SDS.

6. The preparation method according to claim 5, wherein in route I, the non-starch polysaccharide solution has 2.5 g/L to 20.0 g/L of the non-starch polysaccharide;
in route II, the non-starch polysaccharide solution has 2.5 g/L to 20.0 g/L of the non-starch polysaccharide;
in route III, the non-starch polysaccharide solution has 5 g/L to 20.0 g/L of the non-starch polysaccharide; and
in route IV, the non-starch polysaccharide solution has 2.5 g/L to 20.0 g/L of the non-starch polysaccharide.

7. The preparation method according to claim 5, wherein in routes Ito IV, the starch and the non-starch polysaccharide solution have a dosage ratio of independently (10-20) g:100 mL.

8. Use of slowly digestible starch (SDS) comprising a starch granule and a non-starch polysaccharide coating coated on a surface of the starch granule;
wherein the non-starch polysaccharide coating is obtained by crosslinking a non-starch polysaccharide with metal ions or the SDS prepared by the following four process routes:
route I:
mixing starch with a non-starch polysaccharide solution to obtain a mixture of the non-starch polysaccharide and the starch; and
subjecting the mixture of the non-starch polysaccharide and the starch to crosslinking and solidification in a metal salt solution to obtain the SDS;
route II:
mixing starch with a non-starch polysaccharide solution to obtain a mixture of the non-starch polysaccharide and the starch; and
drying the mixture of the non-starch polysaccharide and the starch, and subjecting a dried product to crosslinking and solidification in the metal salt solution to obtain the SDS;
route III:
mixing starch with a non-starch polysaccharide solution to obtain a mixture of the non-starch polysaccharide and the starch; and
conducting microcapsule granulation on the mixture of the non-starch polysaccharide and the starch, and subjecting a granulated product to gelatinization in the metal salt solution to obtain the SDS; and
route IV:
mixing starch with a non-starch polysaccharide solution to obtain a mixture of the non-starch polysaccharide and the starch; and
spraying the mixture of the non-starch polysaccharide and the starch into the metal salt solution by electrostatic spraying, and conducting crosslinking and solidification to obtain the SDS.

9. The preparation method according to claim 5, wherein the starch granule comprises one or more of corn starch, potato starch, sweet potato starch, tapioca starch, pea starch, and mung bean starch.

10. The preparation method according to claim 6, wherein in the non-starch polysaccharide coating, the non-starch polysaccharide comprises one or more of sodium alginate, carrageenan, and pectin.

11. The preparation method according to claim 7, wherein when the non-starch polysaccharide is the sodium alginate or the pectin, the metal ions are calcium ions; and when the non-starch polysaccharide is the carrageenan, the metal ions are potassium ions.

12. The preparation method according to claim 9, wherein in route I, the non-starch polysaccharide solution has 2.5 g/L to 20.0 g/L of the non-starch polysaccharide;
in route II, the non-starch polysaccharide solution has 2.5 g/L to 20.0 g/L of the non-starch polysaccharide;
in route III, the non-starch polysaccharide solution has 5 g/L to 20.0 g/L of the non-starch polysaccharide; and
in route IV, the non-starch polysaccharide solution has 2.5 g/L to 20.0 g/L of the non-starch polysaccharide.

13. The preparation method according to claim 10, wherein in route I, the non-starch polysaccharide solution has 2.5 g/L to 20.0 g/L of the non-starch polysaccharide;
in route II, the non-starch polysaccharide solution has 2.5 g/L to 20.0 g/L of the non-starch polysaccharide;
in route III, the non-starch polysaccharide solution has 5 g/L to 20.0 g/L of the non-starch polysaccharide; and
in route IV, the non-starch polysaccharide solution has 2.5 g/L to 20.0 g/L of the non-starch polysaccharide.

14. The preparation method according to claim 11, wherein in route I, the non-starch polysaccharide solution has 2.5 g/L to 20.0 g/L of the non-starch polysaccharide;
in route II, the non-starch polysaccharide solution has 2.5 g/L to 20.0 g/L of the non-starch polysaccharide;
in route III, the non-starch polysaccharide solution has 5 g/L to 20.0 g/L of the non-starch polysaccharide; and
in route IV, the non-starch polysaccharide solution has 2.5 g/L to 20.0 g/L of the non-starch polysaccharide.

15. The preparation method according to claim 9, wherein in routes Ito IV, the starch and the non-starch polysaccharide solution have a dosage ratio of independently (10-20) g:100 mL.

16. The preparation method according to claim 10, wherein in routes Ito IV, the starch and the non-starch polysaccharide solution have a dosage ratio of independently (10-20) g:100 mL.

17. The preparation method according to claim 11, wherein in routes Ito IV, the starch and the non-starch polysaccharide solution have a dosage ratio of independently (10-20) g:100 mL.

18. The use according to claim 8, wherein the starch granule comprises one or more of corn starch, potato starch, sweet potato starch, tapioca starch, pea starch, and mung bean starch.

19. The use according to claim 18, wherein in the non-starch polysaccharide coating, the non-starch polysaccharide comprises one or more of sodium alginate, carrageenan, and pectin.

20. The use according to claim 19, wherein when the non-starch polysaccharide is the sodium alginate or the pectin, the metal ions are calcium ions; and when the non-starch polysaccharide is the carrageenan, the metal ions are potassium ions.
